(19) United States
(12) Patent Application Publication
(10) Pub. No.: US 2011/0173188 A1
(43) Pub. Date: Jul. 14, 2011

(54) SYSTEM AND METHOD FOR MOBILE DOCUMENT PREVIEW

(75) Inventors: Richard J. Walsh, Raleigh, NC (US); Alfredo C. Issa, Apex, NC (US)

(73) Assignee: Oto Technologies, LLC, Raleigh, NC (US)

(21) Appl. No.: 13/040,428

(22) Filed: Mar. 4, 2011

Related U.S. Application Data
(63) Continuation of application No. 12/686,454, filed on Jan. 13, 2010.

(51) Int. Cl. G06F 17/30

(52) U.S. Cl. 707/722; 707/E17.014

(57) ABSTRACT

An apparatus is disclosed which includes a communication interface and a controller associated with the communication interface and configured to receive from a device a request for a preview markup of a document including at least one page, determine a level of detail for the preview markup, and analyze at least one layout element and at least one content element of the at least one page to generate the preview markup having the level of detail.

### CROSS-REFERENCE TO RELATED APPLICATION

This application claims priority to and is a continuation of co-pending U.S. patent application Ser. No. 12/686,454, entitled “SYSTEM AND METHOD FOR MOBILE DOCUMENT PREVIEW,” which was filed on Jan. 13, 2010, and the disclosure of which is hereby incorporated herein by reference in its entirety.

### FIELD OF THE INVENTION

The present disclosure relates to document previews, and specifically relates to the generation and rendering of document previews.

### BACKGROUND OF THE INVENTION

The computationally intensive nature of content browsing and searching operations on a mobile phone taxes the resources on an already resource limited device, which leads to quirky and slow behavior. Flipping through pages of a portable document format (PDF) document or web page on a mobile device, such as an IPHONE® mobile device by Apple, Inc. of Cupertino, Calif., provides an excellent example. IPHONE® mobile device users are often presented with the infamous “checkerboard” indicating that the IPHONE® mobile device is struggling to keep up with document navigation requests (e.g., scrolling, zooming, etc.). It is desirable to provide alternative techniques to minimize the resources required to utilize documents while providing the end user desired content browsing and searching features.

### SUMMARY OF THE INVENTION

An apparatus comprising a communication interface and a controller associated with the communication interface configured to generate and render document previews is provided. In accordance with an exemplary embodiment, the apparatus receives from a device a request for a preview markup of a document comprising at least one page. The requested preview markup is a facsimile of the document that effectively describes the visual attributes of the document while being of a reduced size. Next, a level of detail for the preview markup is determined. The apparatus then proceeds to analyze at least one layout element and at least one content element of the at least one page to generate the preview markup having the determined level of detail.

In accordance with another exemplary embodiment, the apparatus is configured to transmit a request for a preview markup of a document comprising at least one page, wherein the request comprises a level of detail, receive the preview markup having the level of detail, and render the preview markup as a document preview.

In accordance with another exemplary embodiment, a computer readable medium embodied in an article of manufacture is encoded with instructions for directing a processor to receive from a device a request for a preview markup of a document comprising at least one page, determine a level of detail for the preview markup, and analyze at least one layout element and at least one content element of the at least one page to generate the preview markup having the level of detail.

Those skilled in the art will appreciate the scope of the present invention and realize additional aspects thereof after reading the following detailed description of the preferred embodiments in association with the accompanying drawing figures.

### BRIEF DESCRIPTION OF THE DRAWING FIGURES

The accompanying drawing figures incorporated in and forming a part of this specification illustrate several aspects of the invention, and together with the description serve to explain the principles of the invention.

FIG. 1 illustrates exemplary outputs for a device rendering document previews according to an embodiment of the disclosure;

FIG. 2 illustrates a system for providing the generation and rendering of document previews according to an exemplary embodiment of the disclosure;

FIG. 3 illustrates an exemplary document and a corresponding preview markup language and document preview according to an embodiment of the disclosure;

FIG. 4 illustrates exemplary document preview versions having different levels of detail according to an embodiment of the disclosure;

FIG. 5 illustrates a flowchart of the process of generating a preview markup according to an embodiment of the disclosure;

FIG. 6 illustrates a flowchart of the interaction of two devices generating and displaying a preview markup according to an embodiment of the disclosure;

FIG. 7 is a block diagram of the mediating server of FIG. 1 according to one embodiment of the present disclosure; and

FIG. 8 is a block diagram of the user device of FIG. 1 according to one embodiment of the present disclosure

### DETAILED DESCRIPTION OF THE PREFERRED EMBODIMENTS

The embodiments set forth below represent the necessary information to enable those skilled in the art to practice the invention and illustrate the best mode of practicing the invention. Upon reading the following description in light of the accompanying drawing figures, those skilled in the art will understand the concepts of the invention and will recognize applications of these concepts not particularly addressed herein. It should be understood that these concepts and applications fall within the scope of the disclosure and the accompanying claims.

When a request is issued to view a document, the requested document is accessed and converted into a preview markup. The preview markup is a facsimile of the original document wherein each page is broken down into its component parts and recorded, in abbreviated form, in preview markup language. For example, a page in the original document is analyzed and found to consist of two columns of text with an image at the top of the right hand column. Information recording the two columns of text and the size and placement of the image is recorded using preview markup language. Note that neither the actual text comprising each column nor the actual image are described in the preview markup language of the preview markup. Depending on the level of detail desired, the preview markup may describe the contents of the document with relatively less or more detail. Using the preview markup created from the document, a mobile device can render a simplified facsimile of each page of the document as a document preview. As described more fully below, the generation of a preview markup and subsequent rendering of the preview markup as a document preview provides a computationally efficient and intuitive means by which a user can search, browse, and otherwise access the contents of a document.

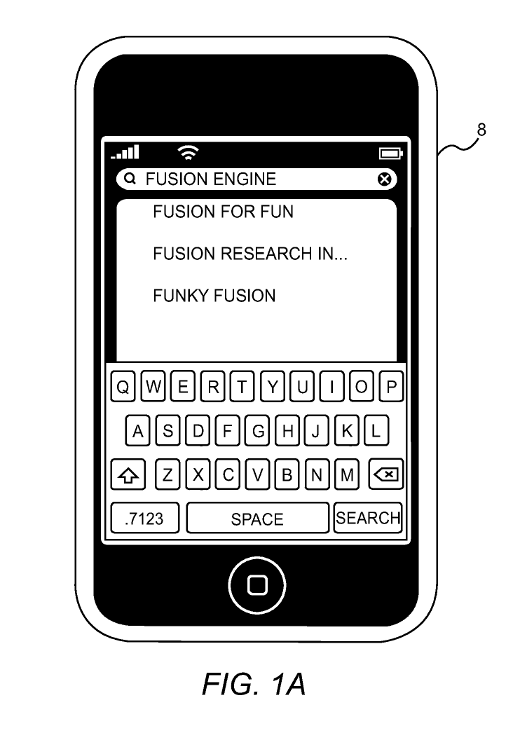

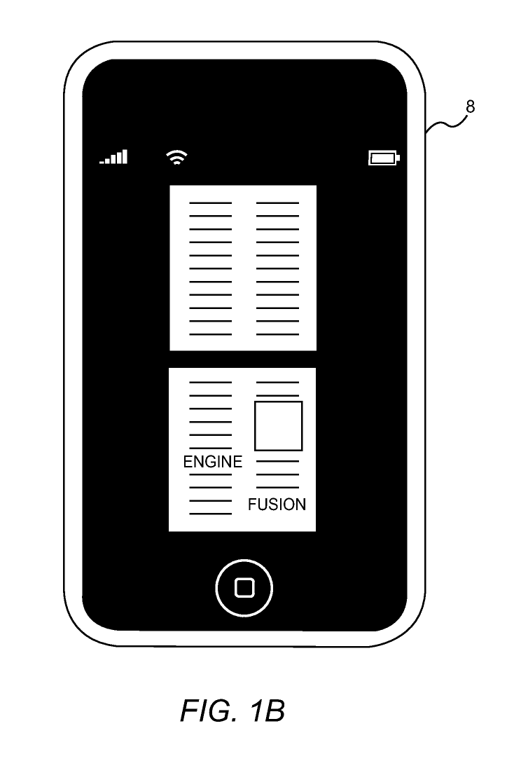

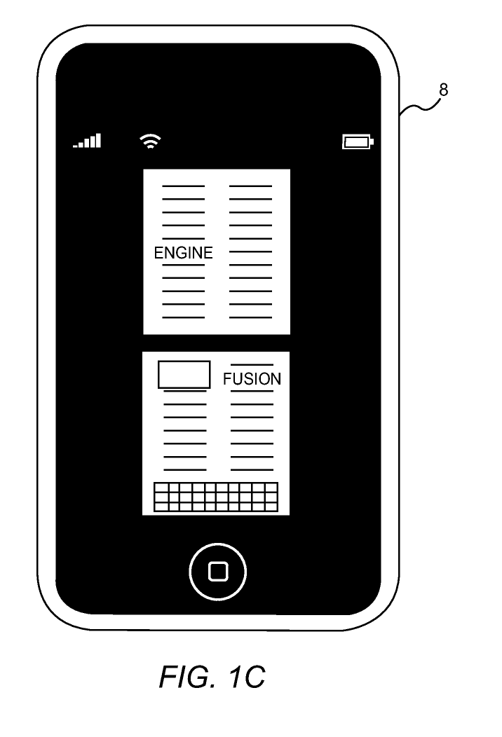

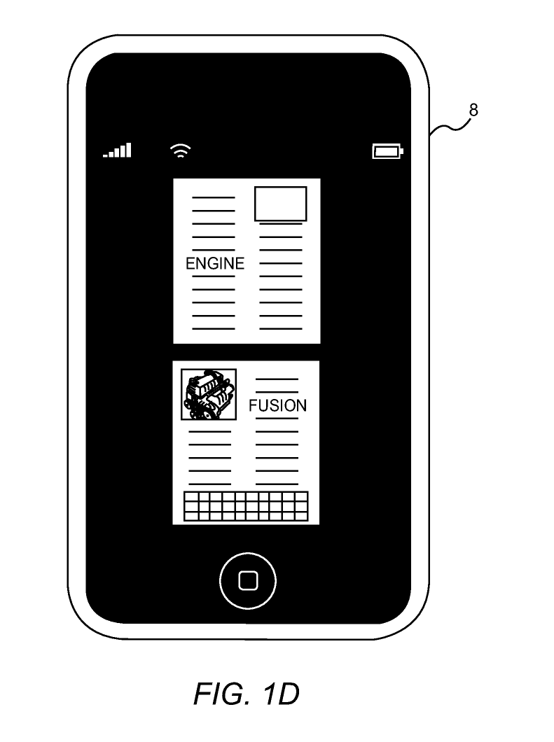

The following example, described with reference to FIGS. 1A-1D, provides an overview of a system and method for providing document preview in accordance with exemplary embodiments disclosed herein. In this example, Alice is at lunch with a colleague discussing nuclear fusion when she recalls reading about a related idea from a research team from MIT. Alice uses her IPHONE® mobile device 8 to enter a search query using a document search tool that has access to Alice's large collection of research papers stored on various machines at work and home. The document search service on each of her machines receives and performs the search query. The search query indicates that the response message should include a preview markup tailored for IPHONE® mobile device capabilities and Alice's preferences.

Alice's IPHONE® mobile device 8 receives the search results and displays a list of documents which match the search query (FIG. 1A). Alice recalls that the document she is looking for has a picture of a fusion engine with a table underneath it detailing the engine's performance characteristics. Alice selects the first document in the list and her IPHONE® mobile device 8 displays the document preview for each of the pages in the document. The pages with search hits for her terms (fusion, engine) are presented with a higher level of detail than pages without a match (FIG. 1B).

In this example, the first document is not the one Alice wants, so Alice selects the next document in the list and her IPHONE® mobile device 8 displays the associated document preview. Alice skims through the document and finds the page with the image and table (FIG. 1C). Alice's IPHONE® mobile device 8 detects that she has spent over two seconds looking at the page and is triggered to automatically issue a request to her work machine (where the document resides) to obtain the highest level of document preview detail for this page. The IPHONE® mobile device 8 receives the response and modifies the document preview of the page to the highest quality available (FIG. 1D). The additional detail provides Alice with confirmation that this is the document she is looking for. Alice double taps the page of the document preview and her IPHONE® mobile device 8 issues a request to her work machine to fetch the actual document. Alice's IPHONE® mobile device 8 receives and presents the document and she discusses the details of the fusion engine with her colleague as they eat their lunch.

In accordance with various exemplary and non-limiting embodiments, preview markups are described for mobile devices that require minimal resources to create, share, and present. As used herein, “preview markup” refers to a formatted description of the visual aspects of a document, described using preview markup language, including, but not limited to, the layout (e.g., page orientation, margins, etc.), content elements (e.g., text, images, tables, etc.), and non-visible aspects such as metadata (e.g., annotations, modified sections, etc.). As used herein, a “document preview” refers to a rendered preview markup or portion of a preview markup.

As used herein, a “mobile device” refers to a computing device capable of receiving inputs, processing information, and displaying outputs and able to be carried on the person of a user. Examples of mobile devices include, but are not limited to, cell phones, personal digital assistants (PDAs), laptops, eReaders, hand held gaming devices, and the like. In exemplary descriptions below in which a device is a mobile device, the terms “device” and “mobile device” may be used interchangeably.

As described more fully below, the level of visual accuracy described by a preview markup can vary based on a number of factors such as device capabilities, user preferences, document type, total size constraints, processing time constraints, bandwidth, location, and the like. In addition, a preview markup can include information to visually identify locations within a document that are relevant to a user based on preferences or search criteria. A device, such as a mobile device, renders a document preview based on the preview markup in response to a user's document browsing, navigation, and search actions.

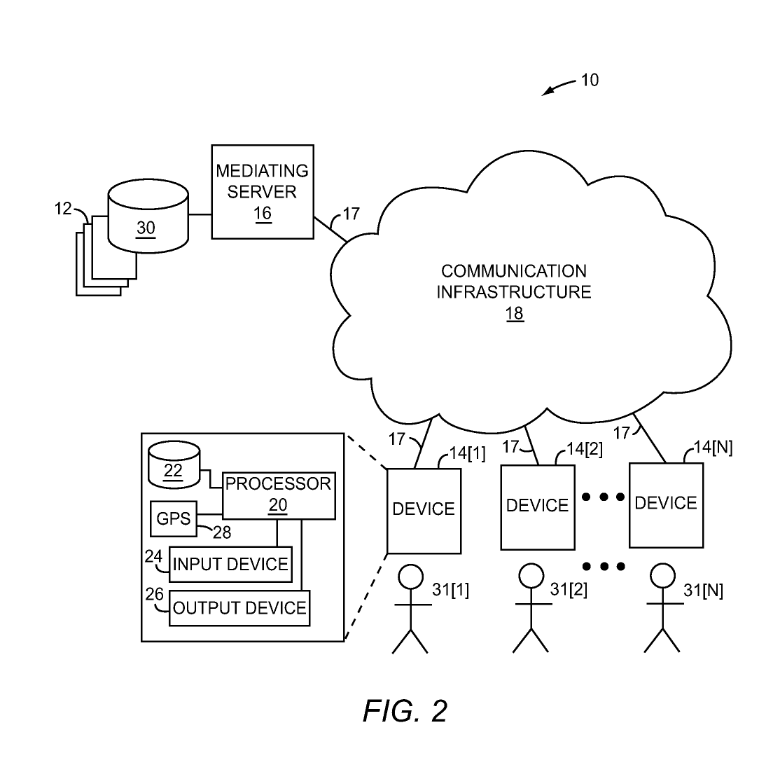

FIG. 2 illustrates an exemplary and non-limiting embodiment of a system 10 for generating a preview markup of a document 12 and rendering the preview markup as a document preview on a device 14, such as the IPHONE® mobile device 8, according to exemplary embodiments disclosed herein.

Each device 14[1-N] may communicate, in either a wired or wireless fashion, with another entity including, but not limited, to another device 14, a mediating server 16, and a cloud computing infrastructure (not shown). The devices 14[1-N] may be mobile devices, such as a mobile phone, a PDA, a laptop, and the like. Alternatively, the devices 14[1-N] may be desktop computing devices.

Each device 14[1-N] is configured to communicate with other devices 14 and entities via network 17. The network 17 may be any type of wired network, any type of wireless network, or any combination thereof. A communication infrastructure 18 may be interspersed between entities coupled via the network 17. The communication infrastructure 18 encompasses any and all infrastructures capable of transmitting analog or digital data, including data packets, between entities using either wired or wireless communication. In an exemplary embodiment, each device 14[1-N] and any other entity, such as the mediating server 16, may communicate directly via a wired or wireless connection, such as Bluetooth.

Each device 14[1-N] comprises a processor 20 for performing instructions such as might be embodied in a computer readable medium. The processor 20 may include internal storage capacity and may communicate with one or more databases 22 on which may be stored, for example, one or more documents. The processor 20 may communicate with an input device 24 to receive inputs and may display outputs, such as a document preview, on an output device 26. The processor 20 may further receive geospatial information via a Global Positioning System (GPS) component 28. The mediating server 16 may likewise receive inputs, such as requests for documents, generate preview markups, such as by accessing one or more documents from a database 30 and performing computations thereupon, and may provide outputs, such as response messages described more fully below. Each device 14[1-N] may be operated by an associated user 31 [1-N].

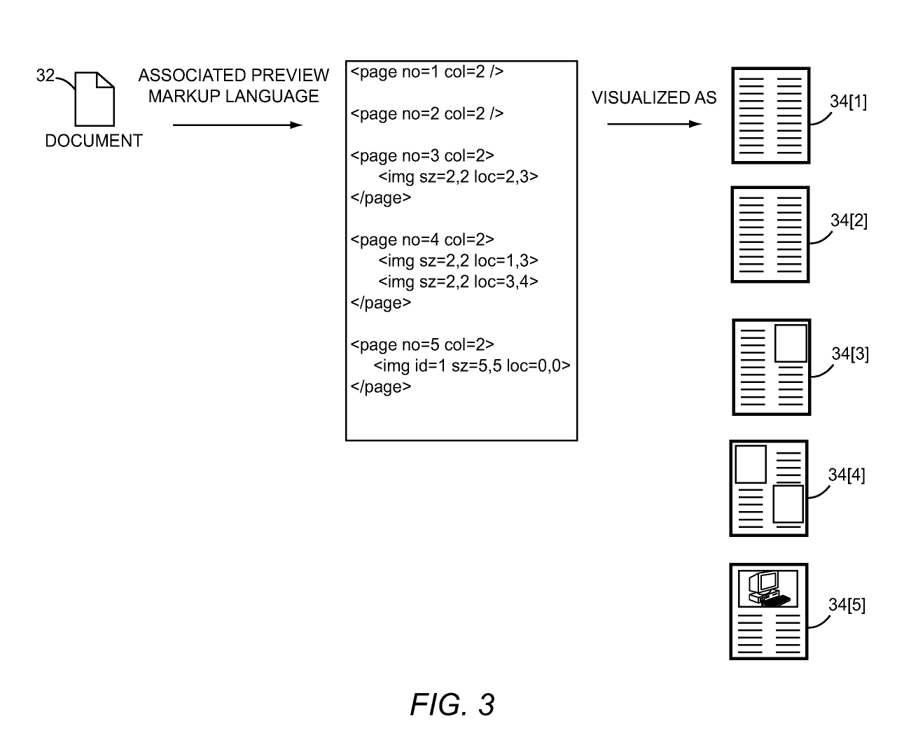

With reference to FIG. 3, an example of a document 32 and the preview markup language associated therewith is illustrated. The preview markup language may be used by a device 14, such as a mobile device 14, to visually describe the document 32 to a user in a manner that is efficient to load, share, and present. A preview markup, describing a document in preview markup language, specifies visual aspects of pages within a document such as content (text, figures, tables, images), content layout (number of columns, margins, whitespace), and non-visible aspects such as metadata comprising edit locations, versioning, annotations, and the like. As illustrated, the document 32 is translated into preview markup language. In the exemplary embodiment illustrated, the preview markup language comprises an Extensible Markup Language (XML) text string. In practice, the format of the preview markup language may be any format capable of specifying aspects of the document 32 including, but not limited to, postscript, a binary format, Scalable Vector Graphics (SVG), and the like.

In the present example, the document 32 is formed of five pages. The translation of the first page into preview markup language is “<page no=1 col=2/>”. Note that this is merely a description of some of the aspects of page one of the document 32. Specifically, the preview markup language description of page one consists of a page identifier “page no=1” and a description of a page layout “col=2” having two columns. When a facsimile of page one is rendered according to the preview markup language, a rendered page 34[1] is generated, which is a generic page having two text columns. Note that the actual words in each column are generic and do not necessarily match the words comprising the original version of the rendered page 34[1] in the document 32. In an alternative exemplary embodiment, the words in each column may be blurry or otherwise indicative of being a placeholder or facsimile.

The translation of the third page into preview markup language is:

<page no=3 col=2>

<img sz=2,2 loc=2,3>

</page>

As before with reference to page one, the preview markup language description of page three consists of a page identifier “page no=3” and a description of a page layout “col=2” having two columns. In addition, the description of page three further specifies an image having a size and a placement in the upper right corner. As a result, when a facsimile of page three is rendered according to the preview markup language, the rendered page 34[3] is a generic page having two text columns and a blank image in the upper right corner. Note that the actual words in each column are generic and do not necessarily match the words comprising the original version of rendered page 34[3] in the document 32. Further, an outlined rectangle indicates the placement of a generic image on the rendered page 34[3].

Continuing, a rendered page 34[4] likewise has two columns of text interrupted by two generic images, one image in the upper left corner and another image in the lower right corner. With reference to page five, the preview markup language description of page five consists of a page identifier “page no=5”, a description of a page layout “col=2” having two columns, and an image having a size and a placement at the top. In addition, an image identifier, “id=1”, is provided. As a result, when page five is rendered, rendered page 34[5] includes both the generic rectangle bounding the image as well as an image, defined by the image identifier “1”, inside the rectangle.

Therefore, FIG. 3 shows that the contents of a document 32 can be described in preview markup language such that the contents comprising, for example, pages of the document 32 can be rendered in such as way that the general visual aspects of the pages of the document 32 are preserved.

A single document can have one or more associated preview markups that offer varying degrees of visual presentation accuracy, or “level of detail,” of the document. As described more fully below, different preview markup versions of a document each having a separate degree of visual presentation accuracy allow for devices, such as mobile devices, to utilize a preview markup version that corresponds to the display capabilities of the device. Having multiple versions further allows for a mobile device to select a preview markup version that best suites the user context (e.g., scrolling, zooming, etc.). Different preview markup versions may be used in combination such as by utilizing a lower quality version first and incrementally loading and progressively utilizing higher quality versions as more detail is desired.

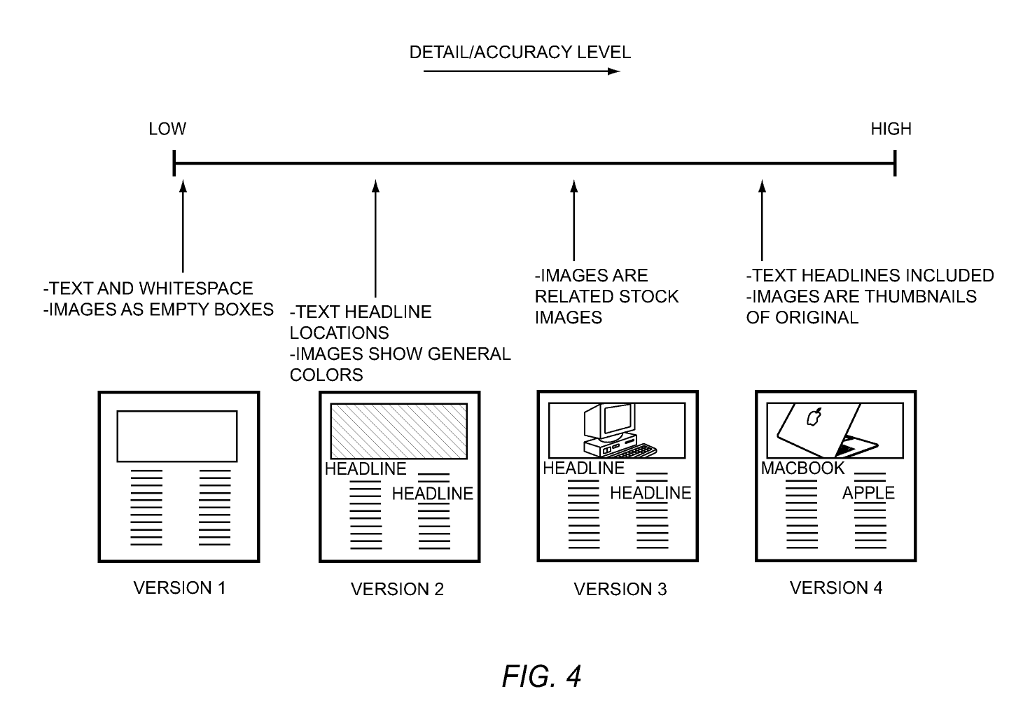

FIG. 4 illustrates an exemplary embodiment of preview markup versions of a single page, each preview markup version having a different level of detail. As illustrated, the four exemplary versions increase in visual presentation accuracy from left to right across a spectrum of visual presentation accuracy extending from “low” to “high” on a scale of Detail/Accuracy Level. At the low end, the rendered preview markup version simply contains information to generally show the basic layout of an associated page in a document. Higher detail levels include additional visual information to help the user understand the page. Note that there is no rigidly defined metric by which the level of detail of individual preview markup versions are measured or otherwise defined. Rather, different preview markup versions are identified by their level of visual presentation accuracy relative to each other preview markup version and are determined, as described more fully below, based on various factors.

For example, when rendered, preview markup version 1 displays text as generic text having the proper number of columns and white space while rendering images as empty rectangles in their proper place and having a proper size. Rendered preview markup version 2, having a higher level of detail than preview markup version 1, adds the bolded and enlarged word “headline” at the approximate place that a headline appears in the corresponding page of the document from which the preview markup version 2 is derived. In addition, the image of preview markup version 2 is colored to reflect the color of the image from which it was derived. Continuing along the scale, rendered preview markup version 3 increases visual presentation accuracy by rendering the image using a stock image. Finally, rendered preview markup version 4 renders the image using an actual thumbnail of the original image of the document from which the preview markup version 4 is derived. In addition, the preview markup version 4 includes the actual text of headlines from the corresponding page of the document from which the preview markup version 4 is derived.

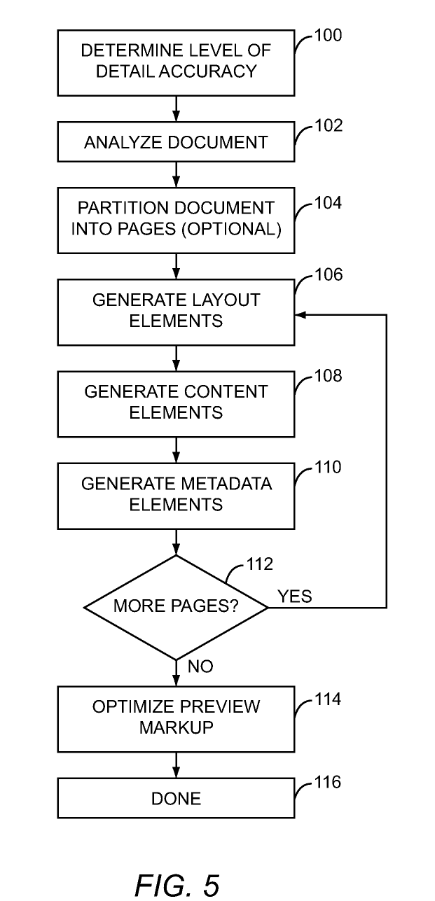

FIG. 5 is an illustration of a flowchart showing the steps involved in generating a preview markup to be rendered by a device 14, such as a mobile device or a mediating server, as a document preview. The generation of a preview markup may be performed by or on various devices and platforms and may be triggered by various events as described more fully below. For example, the process of generating a preview markup may be performed by a documentation tool including, but not limited to, MS Word, Apple Pages, OpenOffice, Google Docs, and the like. The generated preview markup can be included as metadata in the document or in an associated file. In another exemplary embodiment, a device 14 performs the process of generating a preview markup when a document is transferred to the device 14, when a document fetch request is received, or when a search query is performed.

In accordance with another exemplary embodiment, a cloud based service can perform the process of generating a preview markup on behalf of a device 14. For example, a device 14 queries a cloud service with a known document identifier (e.g., title, International Standard Book Number (ISBN)) and a desired document preview level of detail. If the cloud based service has already processed the requested document to generate a preview markup having the desired detail level, the cloud based service can return the previously generated preview markup. If not, the device 14 can transfer the document to the cloud based service, such as via a network, or the device 14 may transfer a reference to the document to the cloud based service allowing the cloud based service to retrieve and process the document to generate the preview markup. In accordance with an alternative embodiment, a mediating server in between a device 14 and a content source, such as a database, a mobile device 14, cloud storage, a home personal computer (PC), etc., performs the process of generating a preview markup upon detecting a document transfer response. The mediating server may be or form part of a wireless access point, a cellular base station (i.e., a femtocell), a network router, and the like.

In accordance with an exemplary embodiment, the mediating server can include a preview markup with a document transfer response message described more fully below. In yet another exemplary embodiment, the mediating server can combine the generated preview markup with the document's metadata and transfer the modified document to the requesting device 14 in lieu of the original document. In yet another embodiment, the mediating server can include a reference in the document transfer response message or in the document's metadata that can be used to fetch the preview markup.

The process starts with a determination of the level of detail (step 100). The level of detail of the generated preview markup may be determined based upon one or more attributes including, but not limited to, user preferences, document type, device information, popular settings, total size constraints, processing time constraints, bandwidth, and the like. For example, consider a document having a second page with two columns of text, an image, and a table. Further assume that the required level of detail for the second page has been determined to be relatively low. The following portion of a preview markup describing the second page might appear as follows:

<page number=2>

<layout style=portrait margins=1,1,1,1 text-columns=2 />
<content type=image size=20,20 location=100,50 />
<content type=table size=20,100 location=300,10 />

</page>

Were a relatively higher level of detail required for the same second page, the preview markup would include additional details that refine characteristics of the text, image, and table content elements. For example, the preview markup describing the second page and having a relatively higher level of detail might appear as follows:

<page number=2>

<layout style=portrait margins=1,1,1,1 text-columns=2 />
<content type=text column=1 spacing=single font-size=medium />
<content type=text column=2 spacing=double font-size=medium />
<content type=image size=20,20 location=100,50 colors=blue,
black/>
<content type=table size=20,100 location=300,10 header-type=text
data-type=numbers />

</page>

Note that in the exemplary preview markup having a relatively higher level of detail, the text content elements further define the line spacing and font size for each column. Further, the image content element includes the colors in the image. Likewise, the table element defines the type of information in the table column headers and table cell data.

The process continues with selection and execution of a document analyzer based, for example, on the type of the document to obtain layout, content, and metadata elements of the document (step 102). Layout elements include, but are not limited to, landscape/portrait settings, page size, margins, spacing, content locations, and the like. Content elements include, but are not limited to, text, images, tables, background, footer/header, watermarks, fonts, colors, and the like. Metadata elements include version history, modifications, size, word count, bookmarks, annotations, etc. As an example, a portable document format (PDF) document analyzer reads in the well known PDF file format and scans through the document to determine margins, text locations, annotations, and so forth. Similarly, a Hypertext Markup Language (HTML) document analyzer reads in a HTML file format and referenced Cascading Style Sheet (CSS) files to determine layout, content, and metadata elements.

Next, the document may be optionally paginated (step 104). For example, a document in a PDF file format has page constructs in the format; however, a document stored in an HTML file format may be one long page resulting in a document preview that is hard to visualize. In an exemplary embodiment, the manner in which the document is partitioned into individual pages depends, in part, upon the display capabilities (size, zoom, etc.) of the device 14 upon which the document preview is to be displayed. The methodology by which the display capabilities of the device 14 are determined depends, at least in part, upon on the environment in which the preview markup generation process is executing. For example, if the process executes on a device 14 requesting the document preview, the process can operate to query the operating system of the device 14 for the information. In another embodiment, if the process executes on a cloud service, the request to generate the document preview can include device capabilities. In another embodiment, if the process executes on a mediating server 16, the device capabilities may be included in messages or deduced from monitoring network traffic.

Next, the generation process analyzes each page of the document in an iterative fashion to generate a preview markup (steps 106 through 112). While illustrated as separate and distinct logical operations, each of steps 106 through 112 may be performed at the same time. Layout elements are generated in preview markup language to describe how the content elements are to be rendered in a document preview (step 106). For example, a portion of a preview markup may be generated that describes a document page as having a page size of A4, a portrait page orientation, a two column layout, margins of 1.5 inches on each side, two text content elements with dimensions and location on the page, and one image content element with dimensions and location on the page.

Next, the content elements are generated in preview markup language to provide a visual representation of the content residing on the page (step 108). Each type of content has its own visual aspects that can be represented as illustrated in the following table of content types and associated exemplary visual aspects:

| Content Type | Visual Aspect |
|---|---|
| Text | spacing (single, double spaced), font |
| | (type, size, color), word density |
| Table | number columns, number of rows, data |
| | inside (text, numbers, financial data) |
| Watermark | color, orientation |
| Images | type (picture, drawing, painting), colors, |
| | pixel depth |
| Video | type (genre), bit rate, duration |
| Audio | type (band, genre), quality level, |
| | duration, album |

Next, metadata elements are generated in preview markup language to describe visual representations of non-visible aspects such as document metadata and dynamic contextual information (step 110). For example, preview markup generation is initiated as part of a request in a collaborative document editing application. The generated preview markup includes instructions that identify the current location a user is editing or viewing. A mobile device 14 rendering the preview markup highlights the location by presenting a translucent green rectangle over the area in the document page preview or by overlaying a small picture of the user in that location. Continuing with the collaborative document editing example, a generated preview markup may include document versioning information such that, when rendered, shows highlighted areas that were changed since the previous version of the document. As another example, preview markup generation is initiated as part of a document search request. The generated preview markup includes information that identifies locations within the document that match the search criteria. A mobile device 14 rendering the preview markup may highlight locations that match a portion of the search criteria by presenting blue rectangles and highlight locations that match all of the search criteria by presenting red rectangles. Alternatively, the terms that match the search criteria are overlaid in the document preview at the appropriate locations.

When defining robust content elements such as image and video content elements, a preview markup can include additional information that provides more visual detail by leveraging content already residing on the device 14 on which the preview markup is to be rendered, located on a remote service, or stored on any platform or device in communication with the device 14. For example, consider a page in a document having an image of a fusion engine. When the content elements for the page are generated to form part of a preview markup they may, in lieu of merely identifying the colors within the image, reference an image that is related to the original fusion engine image, such as an image of a car engine. In the present example, the related image of a car engine can be determined in part, for example, using a combination of image recognition and semantic text analysis known in the art. For example, a classification of the original image of the fusion engine can be determined and used to lookup in an ontology or the like to select a semantically relevant image. A reference to the semantically relevant image is referenced in the generated preview markup. An example of an embedded image reference is as follows:

<content type=image size=20,20 location=100,50
reference=http://blah.com/image123 />

Alternatively, the classification result can be included in the preview markup such that the mobile device 14 on which the preview markup is to be rendered can select a relevant image from its local storage or request one from a remote service. An example of an embedded image classification is as follows:

<content type=image size=20,20 location=100,50 classification=engine/>

Note that the mobile device 14, the mediating server, or the cloud service may be provisioned with a set of stock images or may have cached images that were fetched from remote sources when processing previous document previews. Images may be related based upon, for example, their classification with each image and may be assigned a relative level of detail. For example, consider an image having a classification of “automobile.” A primitive outline sketch of a gear provides a low level of image accuracy for use in rendering the document preview. A black and white image of a car engine provides a higher level of detail. A color image of a Ferrari engine has an even higher level of detail, etc.

The process continues repeating steps 106 to 110 until the preview markup language has been generated for each page in the document (step 112).

Next, the markup may be optimized to reduce redundancy. While illustrated as occurring after the generation of preview markup language for all of the pages in a document, such optimization may be performed at any intermediate step such as after the generation of preview markup language for each individual page (step 114). For example, consider a document having 100 pages with the same style (portrait) and the same margins. In such an instance, the final preview markup for the document may include instructions that indicate all of the pages of the document are represented by the same preview markup language rather than including a near identical entry for each page in the preview markup. After optimization, the process ends (step 116).

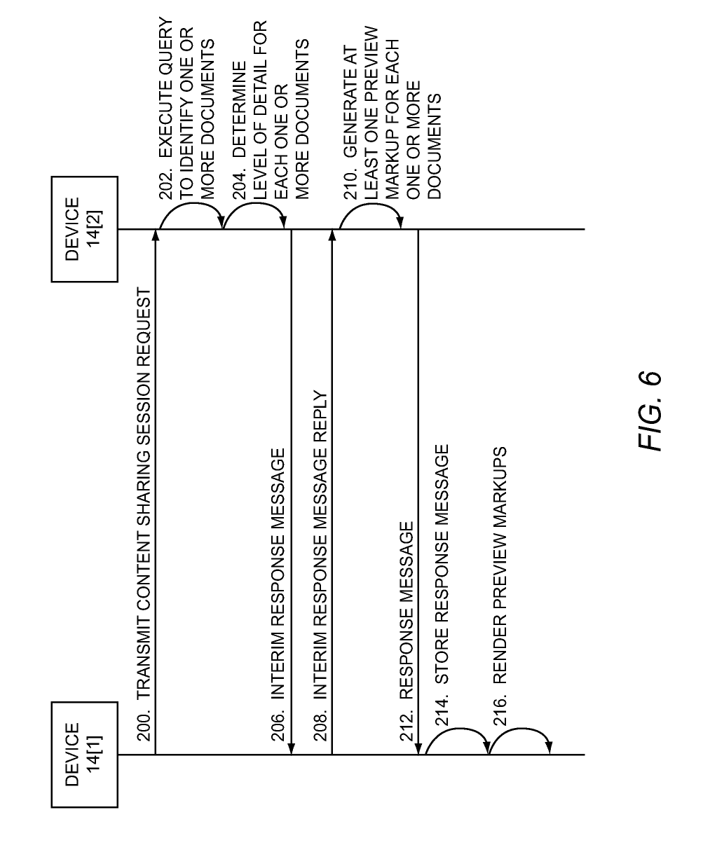

With reference to FIG. 6, an exemplary embodiment of a content sharing session between a first device 14[1] and a second device 14[2] is illustrated. As used herein, “content sharing session” refers, broadly, to any request by a first entity for content, such as a document, from a second entity. While the illustrated embodiment involves a request from a first device 14[1] to a second device 14[2], in practice, the request may be issued by a processor of a first device to an application likewise executed on the processor of the first device. In such an instance, the content sharing session takes place on a single device 14[1].

The first device 14[1] issues a content sharing request to the second device 14[2] (step 200). For example, the first device 14[1] transmits a request to query the second device 14[2] to query for content related to George Washington. The content sharing request indicates that the first device 14[1] desires to receive document previews for the search results. Alternatively, the content sharing service embodied as, for example, executable software embodied in a tangible medium on the second device 14[2], is configured to always include document previews in the search results.

Next, the second device 14[2] executes the operation associated with the content sharing request (e.g., search) and identifies one or more relevant documents to include in the response message (step 202). The second device 14[2] next determines the level of detail or presentation accuracy for the request based upon, in part, the capabilities of the first device 14[1], user information associated with a user of the first device 14[1] (e.g., social network, user profile, etc.), a device context of the second device 14[2] (e.g., battery capacity, network bandwidth between the first and second devices 14[1], 14[2], etc.), user preferences associated with the first device 14[1] (e.g., low level for non-matching pages, medium level for pages with matches), and the like (step 204).

In an exemplary embodiment, the second device 14[2] may send an interim response message to the first device 14[1] that includes summary information about the matching documents (step 206). In response, a user of the first device 14[1] may select a desired level of document preview detail for each matching document and return the desired levels of detail to the second device 14[2] via an interim response message reply (step 208).

Regardless of the method by which the second device 14[2] determines the requisite level of detail for each of the one or more documents, the second device 14[2] proceeds to generate the preview markup (step 210). In an exemplary embodiment, the second device 14[2] performs a check to ascertain whether access exists to previously generated preview markups having the desired level of accuracy such as might already be stored in memory, in one or more document's metadata, or associated files. For documents or portions of documents having no previously generated and accessible preview markups, the second device 14[2] generates preview markups based in part upon the desired level with customizations based on the type of request and user preferences as described above with reference to FIG. 5. For example, the second device 14[2] generates preview markups for a search request wherein preview markup language corresponding to a low level of detail is generated for pages that do not match the search query and preview markup language corresponding to a medium level of detail is generated for pages that do match the search query. In addition, the second device 14[2] may generate preview markup language that represents non-visible aspects that may be relevant to the user. For example, the preview markup may include an overlay red rectangle highlighting a section of a page that the user of the second device 14[2] is currently editing. As another example, overlay blue rectangles identify sections in the document that have changed since the last version. As yet another example, the preview markup may include icon overlays on locations where other users are located in the document.

Next, the second device 14[2] sends a response message to the first device 14[1] which includes information about the identified documents and their associated preview markups (step 212). In an exemplary embodiment, the response message may include either a reference to one or more preview markups or may include the entire preview markup for each of the one or more documents. Information included in the response message may comprise, for example, a listing of document attributes, such as a title or file designation of each document for which a preview markup has been generated, and include the document attributes in the response message. Upon receiving the response message, the first device 14[1] may store the information and preview markups for subsequent use, keep the information and preview markups cached in memory, or maintain links via which the preview markups can be obtained (step 214).

Depending on the application that issued the request, the first device 14[1] proceeds to render the preview markups as document previews (step 216). For example, using the information included in the response message, a list of identified documents disclosed in the response message may be displayed on an output device 26 of the first device 14[1]. When a user operating the first device 14[1] selects a document, such as via an input device 24 of the first device 14[1], the first device 14[1] utilizes the one or more preview markups from the response message to generate a document preview for each page.

In accordance with an exemplary embodiment, a first device 14[1] employs a renderer to display the preview markups. A renderer may be embodied in computer readable instructions for directing a processor 20 to convert the preview markups into rendered document previews such as on an output device 26. In an exemplary embodiment, a renderer may use graphics application program interfaces (APIs) to render in visual form a document preview described in one or more preview markups. In accordance with another embodiment, the renderer generates an image of a page of a document based on the preview markup of the document, stores the image, and the image is displayed to the user.

In accordance with various exemplary embodiments, the first device 14[1] may re-use previously generated user interface components or images that represent a page of a document preview. For example, a renderer uses the preview markup language corresponding to a page to search a cache to identify a previously generated image for an identical or similar preview markup. In accordance with another exemplary embodiment, the first device 14[1] may be provisioned with standard, popular, or preferred images associated with preview markup and stored, for example, in a database 22. For example, a first device 14[1] may be configured with an image that can be used to present a document preview of a preview markup for a page with two columns of text to the user of the first device 14[1]. The renderer may have to fetch content from external sources, such as from a mediating server 16, or select from locally available content, such as stored on a database 22 of the first device 14[1]. In accordance with an exemplary embodiment, the selected content may be based, at least in part, on user preferences. For example, a preview markup defines an image classified as a house and the user of the first device 14[1] on which the preview markup is to be rendered has configured the system to always select an image of user's own house. Similarly, the selected content may be based on location. For example, the renderer selects an image of a southern style house when the user is located in Georgia and selects an image of an igloo when the user is located in Alaska. Such location information may be determined, for example, by a GPS component 28.

As described above, steps 200 through 212, with the exception of steps 206 and 208, may be performed in an ad hoc manner to request preview markups of an individual page or pages of a document based upon a trigger. For example, when scrolling through a document preview comprising a plurality of pages, the renderer or other software, hardware, or firmware responsible for displaying the document preview may request a preview markup of a particular page having a higher level of detail than the document preview of the page currently being displayed. For example, the renderer may operate to request a higher level of detail preview markup triggered based upon a user stopping to view a document preview of the page with a lower level of detail for two or more seconds. In this manner, a user can skim through a document preview while pausing to more carefully examine a particular rendered page that increases in detail as the user observes the rendered page.

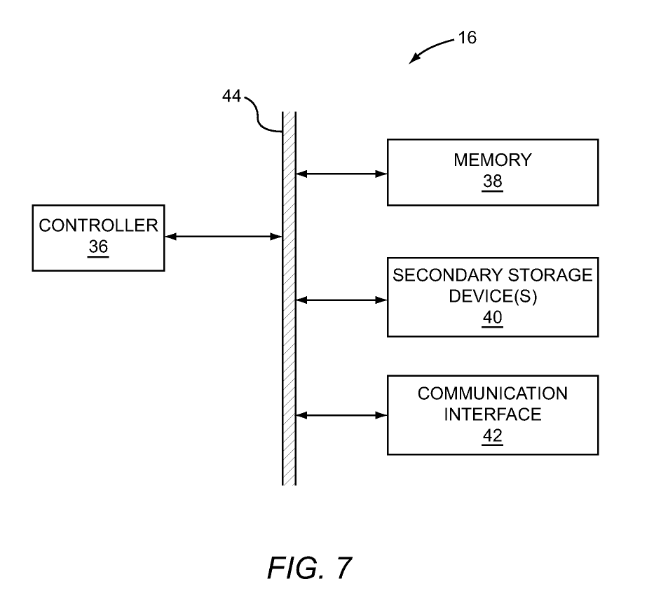

FIG. 7 is a block diagram of the mediating server 16 of FIG. 2 according to one embodiment of the present disclosure. As illustrated, the mediating server 16 includes a controller 36 connected to memory 38, one or more secondary storage devices 40, and a communication interface 42 by a bus 44 or similar mechanism. The controller 36 is a microprocessor, digital Application Specific Integrated Circuit (ASIC), Field Programmable Gate Array (FPGA), or the like. In this embodiment, the controller 36 is a microprocessor, and various preview markup applications and renderers are implemented in software and stored in the memory 38 for execution by the controller 36. Further, depending on the particular embodiment, the database 30 is stored in the one or more secondary storage devices 40. The secondary storage devices 40 are digital data storage devices such as, for example, one or more hard disk drives. The communication interface 42 is a wired or wireless communication interface that communicatively couples the mediating server 16 to the network 17 (FIG. 2). For example, the communication interface 42 may be an Ethernet interface, local wireless interface such as a wireless interface operating according to one of the suite of IEEE 802.11 standards, or the like.

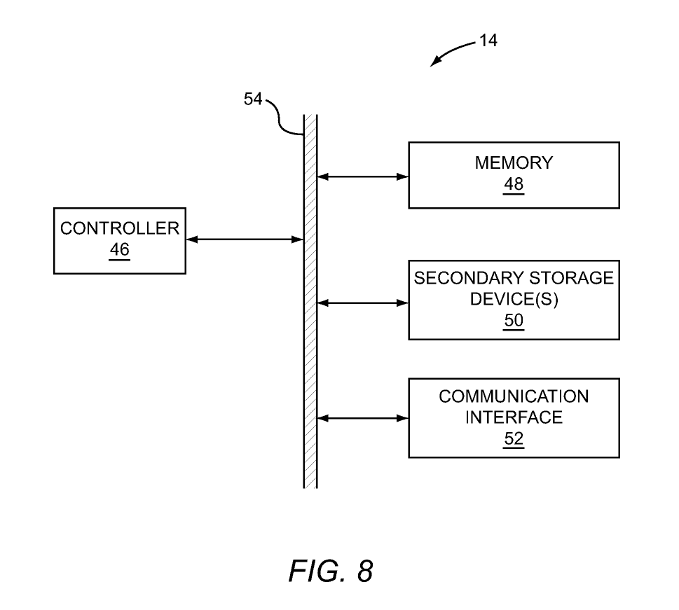

FIG. 8 is a block diagram of the user device 14 of FIG. 2 according to one embodiment of the present disclosure. As illustrated, the user device 14 includes a controller 46 (such as the processor 20), connected to memory 48, one or more secondary storage devices 50 (such as the database 22), and a communication interface 52 by a bus 54 or similar mechanism. The controller 46 is a microprocessor, digital ASIC, FPGA, or the like. In this embodiment, the controller 46 is a microprocessor, and various preview markup applications and renderers are implemented in software and stored in the memory 48 for execution by the controller 46. Further, depending on the particular embodiment, the database 22 is stored in the one or more secondary storage devices 50. The secondary storage devices 50 are digital data storage devices such as, for example, one or more hard disk drives. The communication interface 52 is a wired or wireless communication interface that communicatively couples the user device 14 to the network 17 (FIG. 2). For example, the communication interface 52 may be an Ethernet interface, local wireless interface such as a wireless interface operating according to one of the suite of IEEE 802.11 standards, or the like.

Those skilled in the art will recognize improvements and modifications to the preferred embodiments of the present invention. All such improvements and modifications are considered within the scope of the concepts disclosed herein and the claims that follow.

What is claimed is:

1. An apparatus comprising:
a communication interface adapted to communicate with a network; and
a controller coupled to the communication interface and configured to:
receive a search criteria comprising at least one search term;
obtain a document based on the search criteria which comprises a plurality of words including the at least one search term;
determine term locations within the document wherein the at least one search term occurs;
generate a preview markup that defines a document preview of the document, wherein the preview markup comprises a plurality of overlay identifiers, each of the plurality of overlay identifiers including the at least one search term and an overlay location identifier that identifies a location of an overlay in the document preview that corresponds to a term location of an occurrence of the at least one search term within the document; and
effect rendering of the document preview based on the preview markup.

2. The apparatus of claim 1, wherein the preview markup comprises preview markup language instructions that describe visual aspects of the document, and wherein the preview markup language instructions describe words other than the at least one search term contained in the document such that the words are not discernible in the document preview, and wherein the preview markup language instructions describe the at least one search term in each of the plurality of overlays such that the at least one search term is discernible in the document preview.

3. The apparatus of claim 1, wherein the document preview comprises blurred words which correspond to words contained in the document other than the at least one search term.

4. The apparatus of claim 1, wherein each of the plurality of overlay identifiers further comprises a rectangular border identifier that identifies a rectangular border that surrounds the at least one search term in the document preview.

5. The apparatus of claim 1, wherein the preview markup preserves visual aspects of the document.

6. The apparatus of claim 1, wherein the preview markup is generated at a particular level of detail of a plurality of levels of detail based on a received user preference.

7. The apparatus of claim 1, wherein the preview markup has a first level of detail of a plurality of levels of detail, and further comprising:
determining that the document preview has been rendered for a predetermined period of time; and
based on the determination, rendering a second document preview based on a second preview markup that has a second level of detail which is a greater level of detail than the first level of detail.

8. The apparatus of claim 1, wherein the preview markup comprises a thumbnail image of the document.

9. An apparatus comprising:
a communication interface adapted to communicate with a network; and
a controller coupled to the communication interface and configured to:
receive a search criteria comprising at least one search term;
obtain a plurality of documents based on the search criteria, each of the plurality of documents comprising a plurality of words including the at least one search term;
for each of the plurality of documents:
determine term locations within the document wherein the at least one search term occurs; and
generate a preview markup that defines a document preview of the document, wherein the preview markup comprises a plurality of overlay identifiers, each of the plurality of overlay identifiers including the at least one search term and an overlay location identifier that identifies a location of an overlay in the document preview that corresponds to a term location of an occurrence of the at least one search term within the document.

10. An apparatus comprising:
a communication interface adapted to communicate with a network; and
a controller coupled to the communication interface and configured to:
receive a search criteria comprising at least one search term;
obtain a document based on the search criteria which comprises a plurality of words including the at least one search term;
determine term locations within the document wherein the at least one search term occurs;
generate a first preview markup that defines a first document preview of the document having a first level of detail, wherein the first preview markup comprises a plurality of overlay identifiers, each of the plurality of overlay identifiers including the at least one search term and an overlay location identifier that identifies a location of an overlay in the first document preview that corresponds to a term location of an occurrence of the at least one search term within the document;
effect rendering of the first document preview based on the first preview markup;
generate a second preview markup that defines a second document preview of the document having a second level of detail, wherein the second level of detail is greater than the first level of detail, and wherein the second preview markup comprises a second plurality of overlay identifiers, each of the second plurality of overlay identifiers including the at least one search term and an overlay location identifier that identifies a location of an overlay in the second document preview that corresponds to the term location of the occurrence of the at least one search term within the document;
determining that the first document preview has been displayed for a predetermined period of time; and
in response to determining that the first document preview has been displayed for the predetermined period of time, effecting rendering of the second document preview in place of the first document preview.

11. A method comprising:
receiving a search criteria comprising at least one search term;
obtaining a document based on the search criteria which comprises a plurality of words including the at least one search term;
determining term locations within the document wherein the at least one search term occurs; and
generating a preview markup that defines a document preview of the document, wherein the preview markup comprises a plurality of overlay identifiers, each of the plurality of overlay identifiers including the at least one search term and an overlay location identifier identifying a location of an overlay in the document preview that corresponds to a term location of an occurrence of the at least one search term within the document.

12. The method of claim 11, wherein the search criteria comprises a first search term and a second search term, and wherein first ones of the plurality of overlay identifiers contain the first search term and second ones of the plurality of overlay identifiers contain the second search term, and wherein the first ones of the plurality of overlay identifiers are defined in the preview markup to comprise a first color and the second ones of the plurality of overlay identifiers are defined in the preview markup to comprise a second color that is different from the first color.

13. The method of claim 11, wherein generating the preview markup that defines a document preview further comprises:
generating layout elements which correspond to the document;
generating content elements which correspond to the document; and
generating metadata elements which correspond to the document.

14. A method comprising:
receiving a search criteria comprising a plurality of search terms;
generating a first preview markup that defines a first document preview identifying locations within a document that match the search criteria, wherein the document comprises a plurality of words in addition to the plurality of search terms;
effecting rendering of the first document preview based on the first preview markup such that the plurality of search terms is discernible at locations in the first document preview which correspond to the locations within the document, and the plurality of words is not discernible.

15. The method of claim 14, further comprising:
generating a second preview markup that defines a second document preview identifying the locations within the document that match the search criteria and at least one additional visual aspect of the document which is not defined in the first preview markup;
effecting rendering of the second document preview based on the second preview markup such that the plurality of search terms is discernible at the locations in the first document preview which correspond to the locations within the document, and such that the at least one additional visual aspect is discernible.

16. A non-transitory computer readable medium embodied in an article of manufacture encoded with instructions for directing a processor to:
receive a search criteria comprising at least one search term;
obtain a document based on the search criteria which comprises a plurality of words including the at least one search term;
determine term locations within the document wherein the at least one search term occurs;
generate a preview markup that defines a document preview of the document, wherein the preview markup comprises a plurality of overlay identifiers, each of the plurality of overlay identifiers including the at least one search term and an overlay location identifier that identifies a location of an overlay in the document preview that corresponds to a term location of an occurrence of the at least one search term within the document; and
effect rendering of the document preview based on the preview markup.
